(19) United States
(12) Patent Application Publication
(10) Pub. No.: US 2017/0049150 A1
(43) Pub. Date: Feb. 23, 2017

(54) POWER CONVERTER, POWER CONTROL CIRCUIT AND POWER CONTROL METHOD OF ELECTRONIC CIGARETTE

(71) Applicant: uPI Semiconductor Corp., Hsinchu County (TW)

(72) Inventors: Ya-Ran Xue, Hsinchu County (TW); Heng-Li Lin, Hsinchu County (TW)

(21) Appl. No.: 14/937,809

(22) Filed: Nov. 10, 2015

(30) Foreign Application Priority Data
Aug. 21, 2015 (TW) 104127277

(51) Int. Cl. A24F 47/00; H02J 7/00; H05B 3/00

(52) U.S. Cl. CPC A24F 47/008; H05B 3/0014; H02J 7/007

(57) ABSTRACT

A power converter, a power control circuit, and a power control method of an electronic cigarette are provided. The power converter includes a first terminal, a second terminal, a third terminal, a power output stage, a heating wire switch, and a control circuit. The second terminal acts as a power output terminal. The third terminal is coupled to a heating wire. The power output stage includes a first switch. The control circuit controls an operation of the first switch and an operation of the heating wire switch. When the heating wire switch is turned on, the power output stage operates; when the heating wire switch is turned off, the power output stage stops operating, so as to control the amount of smoke.

### CROSS-REFERENCE TO RELATED APPLICATION

This application claims the priority benefit of Taiwan application serial no. 104127277, filed on Aug. 21, 2015. The entirety of the above-mentioned patent application is hereby incorporated by reference herein and made a part of this specification.

### FIELD OF DISCLOSURE

The disclosure relates to an electronic cigarette technology; more particularly, the disclosure relates to a power converter, a power control circuit, and a power control method of an electronic cigarette.

### DESCRIPTION OF RELATED ART

FIG. 1 is a circuit diagram of a conventional electronic cigarette. Please refer to FIG. 1. The electronic cigarette 100 includes an integrated circuit 110, a microcontroller MCU, an inductor L, and a heating wire 120. The integrated circuit 110 has pins LC1, LC2, VIN, EN, PGND, VOUT, and FB. The microcontroller MCU is coupled between the pin VOUT and the pin FB. The heating wire 120 is coupled between the pin VOUT and the ground GND. In the electronic cigarette 100, the load current flowing from the pin VOUT remains constant. The microcontroller MCU is configured to control a feedback signal of the integrated circuit 110, so as to control the output voltage at the pin VOUT and further control the power of the electronic cigarette 100. Since the microcontroller MCU is responsible for controlling the output voltage, the electronic cigarette 100 often requires other detecting circuits (not shown) to assist the microcontroller MCU in generating a pulse width modulation (PWM) control signal 130.

FIG. 2 is a circuit diagram of another conventional electronic cigarette. Please refer to FIG. 2. The electronic cigarette 200 includes a PWM control circuit 210, switches 211-214, a heating wire 220, a capacitor 222, comparators 224-225, and a microcontroller MCU. The electronic cigarette 200 is characterized by a buck-boost mechanism. The microcontroller MCU controls a feedback path from an output voltage VOUT1 to the PWM control circuit 210, and a feedback circuit includes the comparators 224-225. The electronic cigarette 200 adjusts the output voltage VOUT1 by using the microcontroller MCU to output signals to the PWM control circuit 210 through the comparators 224-225.

The conventional electronic cigarettes 100 and 200 both employ the microcontroller MCU, and both of the electronic cigarettes 100 and 200 output the fixed load current and control the power by controlling the output voltage. While the microcontroller MCU is employed, other complicated circuits are often required for detection, and therefore the area occupied by the microcontroller MCU and the complicated circuits is relatively large in comparison with the area occupied by the overall circuit.

### SUMMARY

The disclosure is directed to a power converter, a power control circuit, and a power control method of an electronic cigarette, so as to resolve conventional issues as exemplarily provided above.

In an embodiment of the invention, a power converter of an electronic cigarette is provided. The power converter is coupled to a heating wire. The power converter includes a first terminal, a second terminal, a third terminal, a power output stage, a heating wire switch, and a control circuit. The first terminal is coupled to a power source. The second terminal acts as a power output terminal. The third terminal is coupled to the heating wire. The power output stage includes a first switch and is coupled between the first terminal and the second terminal. The heating wire switch is coupled between the second terminal and the third terminal. The control circuit is coupled to the power output stage and the heating wire switch to control an operation of the first switch and an operation of the heating wire switch. When the heating wire switch is turned on, the power output stage operates, and when the heating wire switch is turned off, the power output stage stops operating.

According to an embodiment of the disclosure, the control circuit includes a control signal generating circuit and a PWM control circuit. The control signal generating circuit is configured to generate a control signal. The PWM control circuit is coupled to the control signal generating circuit, the power output stage, and the heating wire switch. The PWM control circuit receives the control signal to provide a first signal for operating the first switch and a second signal for operating the heating wire switch.

According to an embodiment of the disclosure, the power converter further includes an enabling control circuit. The enabling control circuit is coupled to the control signal generating circuit and the PWM control circuit and configured to determine whether an enabling signal is received. When the electronic cigarette is in a smoking mode, the enabling signal is generated, and after the enabling control circuit receives the enabling signal, the enabling control circuit enables the control signal generating circuit and the PWM control circuit to operate.

According to an embodiment of the disclosure, the control signal generating circuit includes a reference voltage generating circuit, a ramp generator, and a comparator. The reference voltage generating circuit is configured to generate a reference voltage. The ramp generator is configured to generate a ramp signal. The comparator compares the reference voltage and the ramp signal to generate the control signal.

According to an embodiment of the disclosure, the reference voltage generating circuit generates the reference voltage through resistive voltage division.

According to an embodiment of the disclosure, the reference voltage generating circuit includes a filter, and a pulse width modulation (PWM) signal is converted into the reference voltage by the filter.

According to an embodiment of the disclosure, a duty cycle of the second signal is adjusted by adjusting a level of the reference voltage.

In an embodiment of the disclosure, a power control method of an electronic cigarette for controlling a power output stage and a heating wire switch of the electronic cigarette is provided. The power control method includes steps of: generating an enabling signal when the electronic cigarette is in a smoking mode, providing a control signal according to the enabling signal, generating a first signal and a second signal according to the control signal, controlling the power output stage according to the first signal, and controlling the heating wire switch according to the second signal. The power output stage and the heating wire switch synchronously operate. When the control signal is disabled, the first signal and the second signal are disabled.

According to an embodiment of the disclosure, the step of providing the control signal includes providing the control signal according to a reference voltage and a ramp signal.

According to an embodiment of the disclosure, the step of providing the control signal includes providing the control signal according to a PWM signal and a ramp signal.

In an embodiment of the disclosure, the power control circuit configured to be coupled to a heating wire is provided. The power control circuit includes an enabling control circuit, a control circuit, a power output stage, and a heating wire switch. The enabling control circuit is configured to determine whether an enabling signal is received. The control circuit is coupled to the enabling control circuit and configured to generate a control signal. The power output stage includes a first switch. The power output stage is coupled to the control circuit. The heating wire switch is coupled to the power output stage, the control circuit, and the heating wire. When the enabling signal is received, the control circuit starts to operate, and the control circuit synchronously operates the power output stage and the heating wire switch according to the control signal.

In view of the above, in the power converter and the power control circuit of the electronic cigarette and according to the power control method of the electronic cigarette, the power output stage and the heating wire switch are combined, and the operation of the heating wire switch is controlled by changing the duty cycle of the control signal, so as to adjust the amount of the current on the heating wire and accordingly adjust the output power of the heating wire. Since no microcontroller is required to be arranged on the path of the feedback circuit in the electronic cigarette provided herein, the electronic cigarette is characterized by its simple structure. From another perspective, compared to the conventional electronic cigarette, the electronic cigarette discussed herein not only has the reduced number of switches but also has the reduced circuit area.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a circuit diagram of a conventional electronic cigarette.

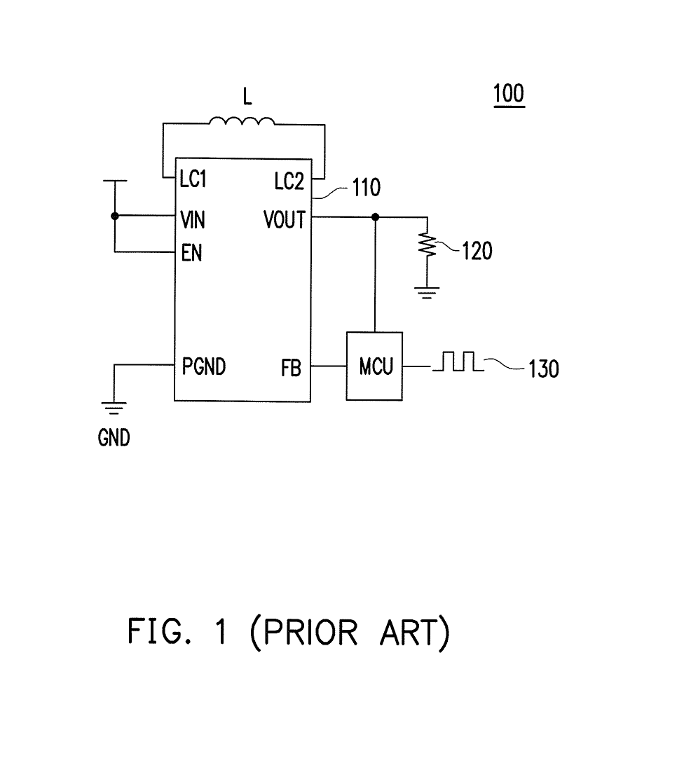

FIG. 2 is a circuit diagram of another conventional electronic cigarette.

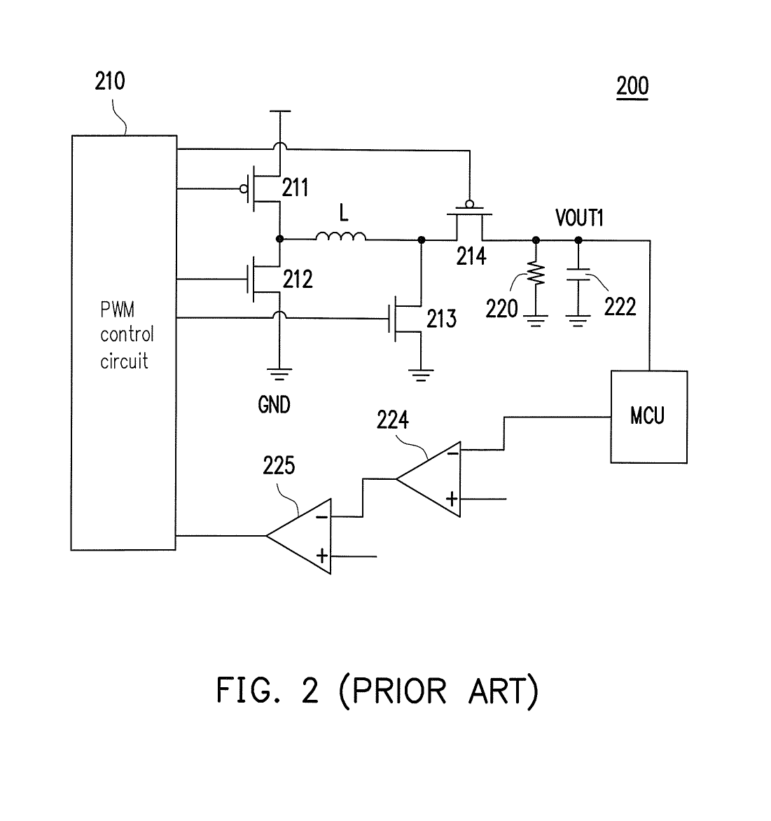

FIG. 3 is a circuit diagram of a power converter of an electronic cigarette according to an embodiment of the disclosure.

FIG. 4 is a schematic diagram illustrating waveforms of a reference voltage and a control signal according to an embodiment of the disclosure.

FIG. 5 illustrates waveforms of various signals according to an embodiment of the disclosure.

FIG. 6 is a flowchart illustrating a power control method according to an embodiment of the disclosure.

### DETAILED DESCRIPTION OF DISCLOSED EMBODIMENTS

Descriptions of the invention are given with reference to the exemplary embodiments illustrated with accompanied drawings, wherein same or similar parts are denoted with same reference numerals. In addition, whenever possible, identical or similar reference numbers stand for identical or similar devices/components in the figures and the embodiments.

In the following embodiments, when one device is “connected to” or “coupled to” another device, the device may be directly connected to or coupled to another device; alternatively, there may be a device between the two connected or coupled devices. The term “circuit” may represent one or plural devices; these devices may be actively and/or passively coupled to each other or one another to perform proper functions. The term “signal” may stand for at least one current, voltage, load, temperature, data, or any other signal. It should be understood that the physical characteristics of the signal discussed throughout the specification and the drawings may be directed to the voltage or the current. The term “synchronous” or “synchronously” indicates the cycle switching actions of the signal are relevant, and the term is not limited to the definition “at the same time”. The term “reference voltage” indicates a direct-current signal or a signal similar to the direct-current signal (with the amplitude lower than 0.05V).

Although the terms “first” and “second” may be applied to describe devices, the interpretation of these devices should not be limited to the literal meaning of these tell is. Instead, these terms merely serve to distinguish one device from another device. For instance, on the premise of not departing from the teachings of the disclosure, the first switch may be called as the second switch, and vice versa.

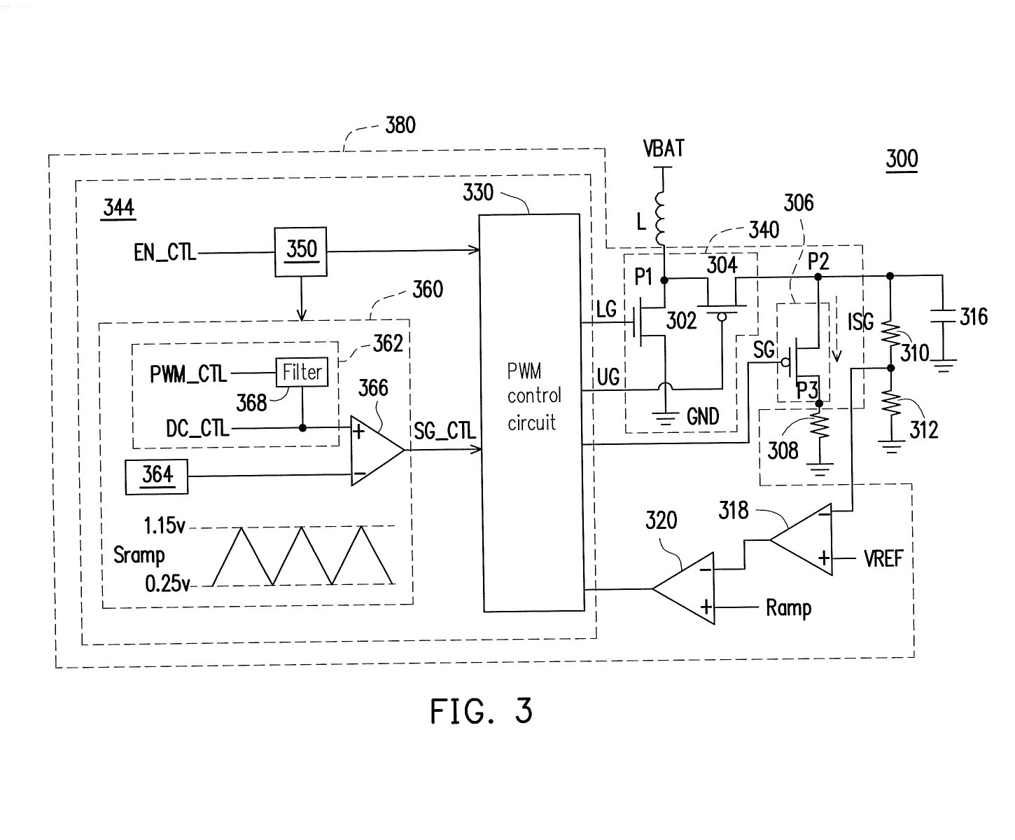

Please refer to FIG. 3. FIG. 3 is a circuit diagram of a power converter of an electronic cigarette according to an embodiment of the disclosure. The power converter 380 of the electronic cigarette 300 includes a first terminal P1, a second terminal P2, a third terminal P3, a power output stage 340, a heating wire switch 306, and a control circuit 344. The first terminal P1 is coupled to a power source (e.g., an operating voltage VBAT). The second terminal P2 acts as a power output terminal. The third terminal P3 is coupled to a heating wire 308. The power output stage 340 includes switches 302 and 304 and is coupled between the first terminal P1 and the second terminal P2. The heating wire switch 306 is coupled between the second terminal P2 and the third terminal P3. The control circuit 344 is coupled to the power output stage 340 and the heating wire switch 306 to control an operation of the switches 302 and 304 and an operation of the heating wire switch 306. When the heating wire switch 306 is turned on, the power output stage 340 operates, and when the heating wire switch 306 is turned off, the power output stage 340 stops operating.

The power output stage 340 may have the boost mechanism and may be equipped with switches in pairs, e.g., the switches 302 and 304. Here, the number of switches of the power output stage 340 is not limited. The power converter 380 serves to control the power source, so as to maintain stability of the output voltage at the power output terminal (the second terminal P2).

The first terminal of the switch 302 is coupled to the operating voltage VBAT through an inductor L, and the second terminal of the switch 302 is coupled to the ground terminal GND. The first terminal of the switch 304 is coupled to the first terminal of the switch 302, and the second terminal of the switch 304 is coupled to the second terminal P2. The capacitor 316 is coupled between the second terminal P2 and the ground terminal GND. The heating wire switch 306 is serially connected to the heating wire 308 and is coupled between the second terminal P2 and the ground terminal GND.

The switch 302 and the switch 304 may be an n-type metal oxide semiconductor (MOS) transistor and a p-type MOS transistor. The heating wire switch 306 may be a p-type MOS transistor.

In particular, the control circuit 344 may include a control signal generating circuit 360 and a PWM control circuit 330. The control signal generating circuit 360 is configured to generate a control signal SG_CTL based on users' needs. The PWM control circuit 330 is coupled to the control signal generating circuit 360, the power output stage 340, and the heating wire switch 306. The PWM control circuit 330 receives the control signal SG_CTL to provide a signal LG for operating the switch 302, a signal UG for operating the switch 304, and a signal SG for operating the heating wire switch 306. Hence, the control circuit 344 may simultaneously operate the switches 302 and 304 and the heating wire switch 306. That is, the control signal SG_CTL may serve to adjust the load current flowing from the second terminal P2 to the ground terminal GND. For instance, the control signal SG_CTL may serve to operate the heating wire switch 306 to change the current ISG flowing through the heating wire 308.

The power converter 380 may further include an enabling control circuit 350. The enabling control circuit 350 is configured to determine whether an enabling signal EN_CTL is received. The enabling control circuit 350 is coupled to the control signal generating circuit 360 and the PWM control circuit 330 and configured to determine whether the enabling signal EN_CTL is received. When the electronic cigarette 300 is in a smoking mode, the enabling signal EN_CTL is generated, and after the enabling control circuit 350 receives the enabling signal EN_CTL, the enabling control circuit 350 enables the control signal generating circuit 360 and the PWM control circuit 330 to operate.

The enabling control circuit 350 may be composed of logic devices, e.g., an AND gate may be configured to determine whether the enabling signal EN_CTL is received. After the enabling control circuit 350 receives the enabling signal EN_CTL, the enabling control circuit 350 enables the control signal generating circuit 360 and the PWM control circuit 330 to operate. Particularly, after the control signal generating circuit 360 operates, the PWM control circuit 330 operates.

The control signal generating circuit 360 may include a reference voltage generating circuit 362, a ramp generator 364, and a comparator 366. The reference voltage generating circuit 362 is configured to generate a reference voltage DC_CTL. The ramp generator 364 is configured to generate a ramp signal Sramp. The comparator 366 compares the reference voltage DC_CTL and the ramp signal Sramp to generate the control signal SG_CTL. Here, the ramp signal Sramp may be called as a triangular wave signal or a jagged wave signal.

The control signal generating circuit 360 is configured to generate a control signal SG_CTL based on users' needs. Specifically, the control signal generating circuit 360 may be generated corresponding to the user's operation of the electronic cigarette 300. For instance, the control signal SG_CTL may be adjusted according to the user's preferential amount of smoke.

Two ways to generate the reference voltage DC_CTL are explained hereinafter.

First way: the reference voltage generating circuit 362 generates the direct-current reference voltage DC_CTL through resistive voltage division (not shown).

Second way: the reference voltage generating circuit 362 may include a filter 368. The PWM signal PWM_CTL is in form of square pulses, and the PWM signal PWM_CTL may be converted into the direct-current reference voltage DC_CTL by the filter 368.

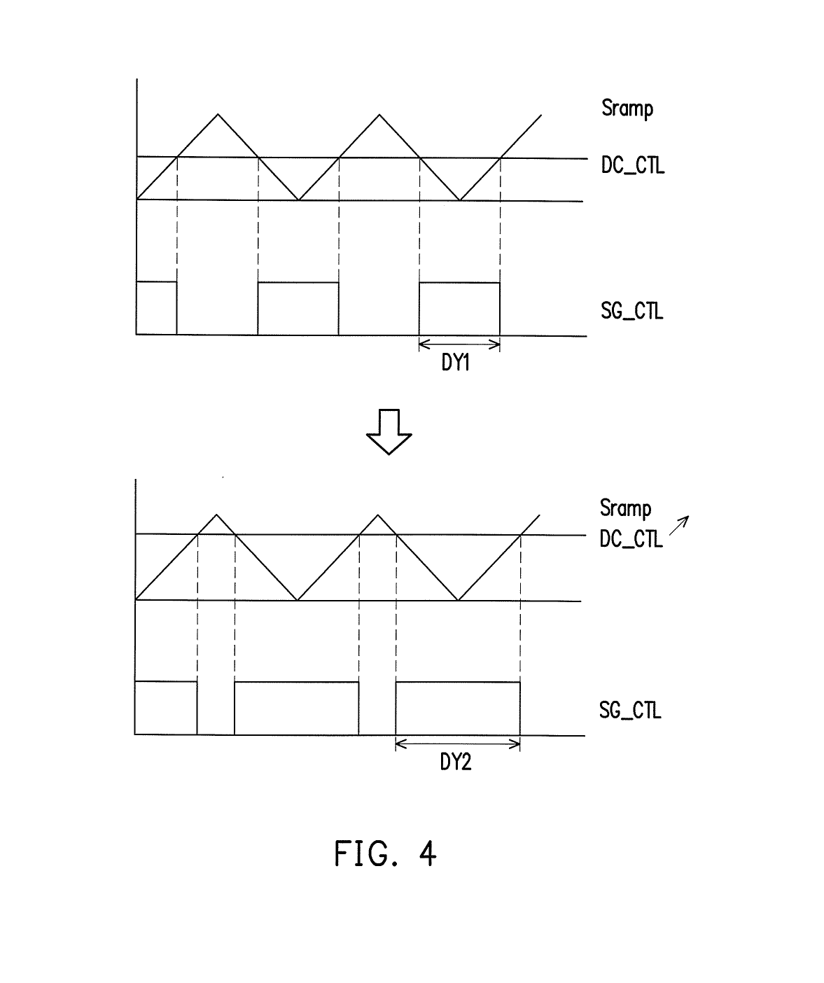

FIG. 4 is a schematic diagram illustrating waveforms is of a reference voltage and a control signal according to an embodiment of the disclosure. Please refer to FIG. 3 and FIG. 4. In an embodiment, the reference voltage DC_CTL may be an adjustable direct-current signal between 0.25V to 1.15V. The minimum peak of the ramp signal Sramp is 0.25V, and the maximum peak of the ramp signal Sramp is 1.15V. When the voltage level of the reference voltage DC_CTL is raised, the corresponding control signal SG_CTL is changed from the duty cycle DY1 to the duty cycle DY2 which is greater than the duty cycle DY1. The increase in the duty cycle of the control signal SG_CTL may lead to an increase in the time during which the cunent flows through the heating wire 308.

Besides, the power converter 380 may further include a feedback circuit. The feedback circuit may include resistors 310 and 312 and comparators 318 and 320. The feedback circuit is coupled to the PWM control circuit 330. The data (the voltage data or the current data) at the power output terminal (the second terminal P2) may be fed back to the PWM control circuit 330 through the resistors 310 and 312 and the comparators 318 and 320. The comparator 318 compares the data and the reference signal REF; after the comparator 320 compares the output signal of the comparator 318 and the ramp signal Ramp, the comparator 320 transmits a resultant comparison signal to the PWM control circuit 330. Here, the ramp signal Ramp may be called as a triangular wave signal or a jagged wave signal.

In addition, if the user sets the electronic cigarette to be in a constant-voltage mode, the paths of the voltage-dividing resistors (the resistors 310 and 312) may not be used, and the voltage at the second terminal P2 may be fixed to a certain voltage level.

In the electronic cigarette 300 shown in FIG. 3, the enabling control circuit 350 may be arranged outside the control circuit 344, i.e., the enabling control circuit 350 is independent from the control circuit 344. Here, the power control circuit may include the enabling control circuit 350, the control circuit 344, the power output stage 340, and the heating wire switch 306. The control circuit 344 is coupled to the enabling control circuit 350. The power output stage 340 is coupled to the control circuit 344. The heating wire switch 306 is coupled to the power output stage 340, the control circuit 344, and the heating wire 308. The enabling control circuit 350 is configured to determine whether an enabling signal EN_CTL is received. The control circuit 344 is configured to generate the control signal SG_CTL. The power output stage 340 includes the switches 302 and 304. When the enabling signal EN_CTL is received, the control circuit 344 starts to operate, and the control circuit 344 synchronously operates the power output stage 340 and the heating wire switch 306 according to the control signal SG_CTL.

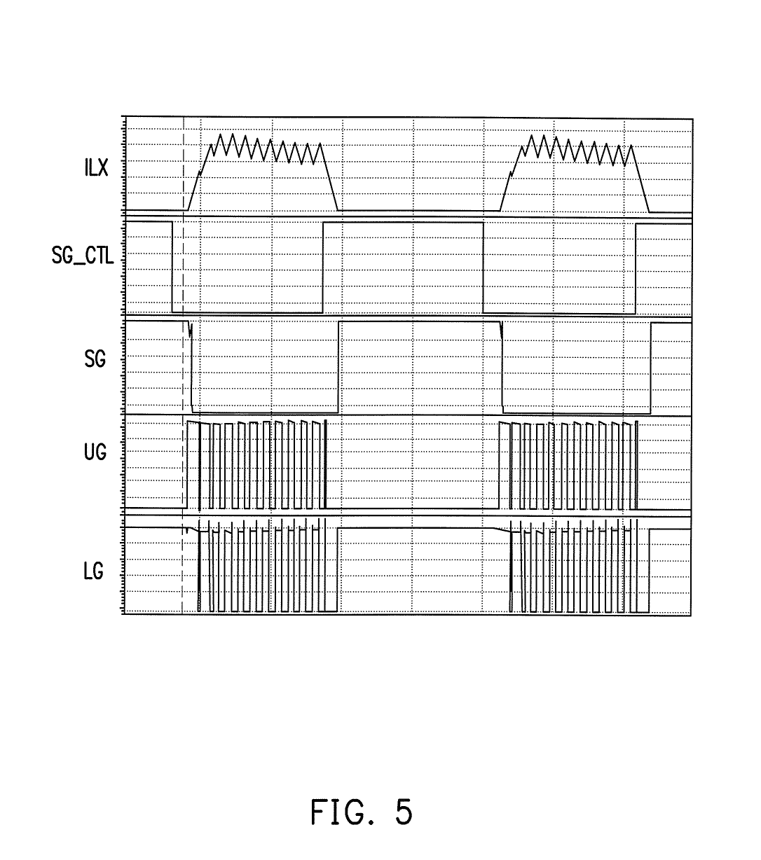

FIG. 5 illustrates waveforms of various signals according to an embodiment of the disclosure. Please refer to FIG. 3 and FIG. 5. The signal ILX serves to represent an inductor current. When the power output stage 340 operates the switches 302 and 304 according to the signals LG and UG, the power output stage 340 enables the boosting circuit to perform the charging and discharging function. Here, the boosting circuit includes the power output stage 340, the inductor L, and the capacitor 316. The boosting circuit must comply with principle of conservation of energy, and the boosting circuit stabilizes the output voltage to be at a certain voltage level by employing an inductive energy storage element. If the control signal SG_CTL is logic high, the switch 302 is switched on, and the switch 304 is switched off, so as to store the energy in the inductor L. If the control signal SG_CTL is logic low, the switch 302 is switched off, and the switch 304 is switched on, so as to transmit the energy stored in the inductor L to the second terminal P2.

It can be derived from the waveform (shown in FIG. 5) that the signals SG, UG, and LG are controlled by the same control signal and are related. The control signal SG_CTL is converted into the signal SG for controlling the heating wire switch 306 through logic calculations. When the signal SG controls the gate terminal of the heating wire switch 306, the switches 302 and 304 of the power output stage 340 start to operate. That is, if the heating wire switch 306 is not switched on, the switch of the power output stage 340 does not operate.

Besides, there may be a time delay between the control signal SG_CTRL and the signal SG. When the signal SG just starts to enable the gate terminal, initial circuit protection measures may be taken. For instance, to prevent a large current from burning down the entire circuit, the heating wire switch 306 is switched on to test the current of 300 mA, and the variations in the voltage level of the third terminal P3 between the heating wire 308 and the heating wire switch 306 are detected. If the voltage level is zero, the heating wire 308 is short-circuited; if the voltage level is not zero, the heating wire switch 306 is allowed to operate normally, and the correspondingly determined current can then flow through the heating wire 308.

Note that the operation of the switch 302 (or the switch 304) and the operation of the heating wire switch 306 are controlled by the same control signal SG_CTL.

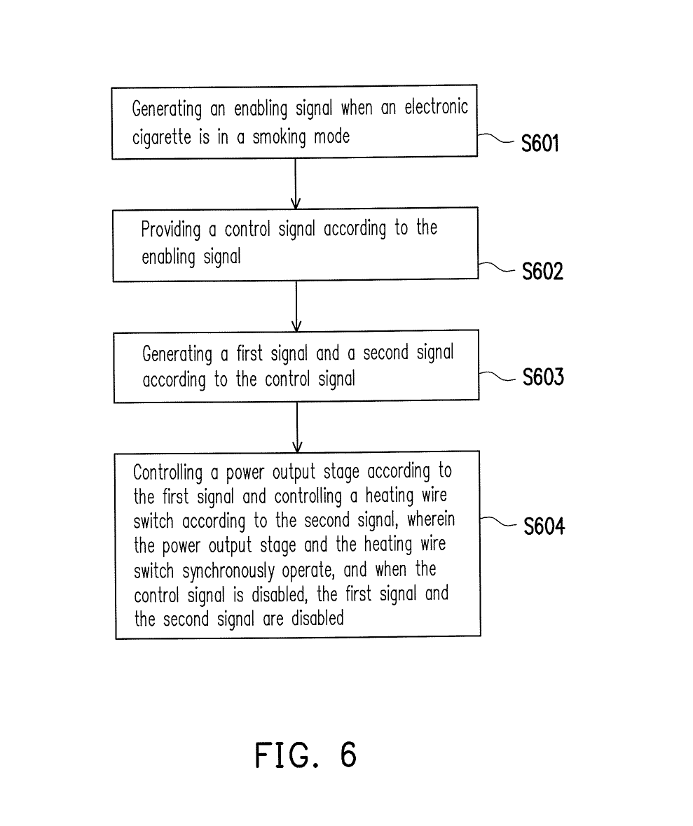

A power control method of a common electronic cigarette may be derived from the previous embodiments and will be described hereinafter. FIG. 6 is a flowchart illustrating a power control method according to an embodiment of the disclosure. With reference to FIG. 3 and FIG. 6, the power control method provided in the present embodiment is applicable to the electronic cigarette 300 for controlling the power output stage 340 and the heating wire switch 306 of the electronic cigarette 300. The power control method includes following steps.

In step S601, an enabling signal EN_CTL is generated when the electronic cigarette is in a smoking mode.

In step S602, the control signal SG_CTL is provided according to the enabling signal EN_CTL. In step S603, the first signal (the signals UG and LG) and the second signal (the signal SG) are generated according to the control signal SG_CTL.

In step S604, the power output stage 340 is controlled according to the first signal, and the heating wire switch 306 is controlled according to the second signal. Here, the power output stage 340 and the heating wire switch 306 synchronously operate; when the control signal SG_CTL is disabled, the first signal and the second signal are disabled.

Besides, the step S602 of providing the control signal SG_CTL may include: providing the control signal SG_CTL according to the reference voltage DC_CTL and the ramp signal Sramp.

Besides, the step S602 of providing the control signal SG_CTL may include: providing the control signal SG_CTL according to the PWM signal PWM_CTL and the ramp signal Sramp.

To sum up, in the power converter and the power control circuit of the electronic cigarette and according to the power control method of the electronic cigarette, the power output stage and the heating wire switch are combined, and the operation of the heating wire switch is controlled by changing the duty cycle of the control signal, so as to adjust the amount of the current on the heating wire and accordingly adjust the output power of the heating wire. Since no microcontroller is required to be arranged on the path of the feedback circuit in the electronic cigarette provided herein, the electronic cigarette is characterized by its simple structure. From another perspective, compared to the conventional electronic cigarette, the electronic cigarette discussed herein not only has the reduced number of switches but also has the reduced circuit area.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A power converter of an electronic cigarette, the power converter being coupled to a heating wire and comprising:
a first terminal coupled to a power source;
a second terminal acting as a power output terminal;
a third terminal coupled to the heating wire;
a power output stage comprising a first switch, the power output stage being coupled between the first terminal and the second terminal;
a heating wire switch coupled between the second terminal and the third terminal; and
a control circuit coupled to the power output stage and the heating wire switch to control an operation of the first switch and an operation of the heating wire switch,
wherein when the heating wire switch is turned on, the power output stage operates, and when the heating wire switch is turned off, the power output stage stops operating.

2. The power converter of claim 1, wherein the control circuit comprises:
a control signal generating circuit configured to generate a control signal; and
a pulse width modulation control circuit coupled to the control signal generating circuit, the power output stage, and the heating wire switch, the pulse width modulation control circuit receiving the control signal to provide a first signal for operating the first switch and a second signal for operating the heating wire switch.

3. The power converter of claim 2, further comprising:
an enabling control circuit coupled to the control signal generating circuit and the pulse width modulation control circuit and configured to determine whether an enabling signal is received,
wherein when the electronic cigarette is in a smoking mode, the enabling signal is generated, and after the enabling control circuit receives the enabling signal, the enabling control circuit enables the control signal generating circuit and the pulse width modulation control circuit to operate.

4. The power converter of claim 2, wherein the control signal generating circuit comprises:
a reference voltage generating circuit configured to generate a reference voltage;
a ramp generator configured to generate a ramp signal; and
a comparator comparing the reference voltage and the ramp signal to generate the control signal.

5. The power converter of claim 4, wherein the reference voltage generating circuit generates the reference voltage through resistive voltage division.

6. The power converter of claim 4, wherein the reference voltage generating circuit comprises a filter, and a pulse width modulation signal is converted into the reference voltage by the filter.

7. The power converter of claim 4, wherein a duty cycle of the second signal is adjusted by adjusting a level of the reference voltage.

8. A power control method of an electronic cigarette for controlling a power output stage and a heating wire switch of the electronic cigarette, the power control method comprising:
generating an enabling signal when the electronic cigarette is in a smoking mode;
providing a control signal according to the enabling signal;
generating a first signal and a second signal according to the control signal;
controlling the power output stage according to the first signal; and
controlling the heating wire switch according to the second signal, wherein
the power output stage and the heating wire switch synchronously operate, and when the control signal is disabled, the first signal and the second signal are disabled.

9. The power control method of claim 8, wherein the step of providing the control signal comprising:
providing the control signal according to a reference voltage and a ramp signal.

10. The power control method of claim 8, wherein the step of providing the control signal comprising:
providing the control signal according to a pulse width modulation signal and a ramp signal.

11. A power control circuit of an electronic cigarette, the power control circuit being configured to be coupled to a heating wire and comprising:
an enabling control circuit configured to determine whether an enabling signal is received;
a control circuit coupled to the enabling control circuit and configured to generate a control signal;
a power output stage comprising a first switch, the power output stage being coupled to the control circuit; and
a heating wire switch coupled to the power output stage, the control circuit, and the heating wire, wherein
when the enabling signal is received, the control circuit starts to operate, and
the control circuit synchronously operates the power output stage and the heating wire switch according to the control signal.

12. The power control circuit of claim 11, wherein the control circuit comprises:
a control signal generating circuit configured to generate a control signal; and
a pulse width modulation control circuit coupled to the control signal generating circuit, the power output stage, and the heating wire switch, the pulse width modulation control circuit receiving the control signal to provide a first signal for operating the first switch and a second signal for operating the heating wire switch.

13. The power control circuit of claim 12, wherein the control signal generating circuit comprises:
a reference voltage generating circuit configured to generate a reference voltage;
a ramp generator configured to generate a ramp signal; and
a comparator comparing the reference voltage and the ramp signal to generate the control signal.

14. The power control circuit of claim 13, wherein the reference voltage generating circuit generates the reference voltage through resistive voltage division.

15. The power control circuit of claim 13, wherein the reference voltage generating circuit comprises a filter, and a pulse width modulation signal is converted into the reference voltage by the filter.
